(19) United States
(12) Patent Application Publication
(10) Pub. No.: US 2020/0122282 A1
(43) Pub. Date: Apr. 23, 2020

(54) CUTTING FLUID TANK FOR MACHINE TOOL

(71) Applicant: OKUMA CORPORATION, Niwa-gun (JP)

(72) Inventors: Seizo Kobayashi, Niwa-gun (JP); Chihiro Matsushita, Niwa-gun (JP)

(21) Appl. No.: 16/597,228

(22) Filed: Oct. 9, 2019

(30) Foreign Application Priority Data
Oct. 18, 2018 (JP) 2018-196784

(51) Int. Cl. B23Q 11/10

(52) U.S. Cl. CPC B23Q 11/1076; B23Q 11/0042; B23Q 11/1069

(57) ABSTRACT

Provided is a cutting fluid tank for a machine tool, which is capable of sufficiently collecting and removing sludge mixed in a cutting fluid even when a chip conveyor or the like is disposed in a tank main body, and with which a location where sludge remains accumulating on a bottom of the tank main body is less likely to occur even when an operation is restarted after being suspended. A cutting fluid tank includes: a tank main body; a first circulation pump; a sludge transfer nozzle configured to eject the sludge-containing cutting fluid pumped out by the first circulation pump, toward a sludge collection pump; a second circulation; and first agitation nozzles configured to eject the sludge-containing cutting fluid that is pumped out by the second circulation pump, toward predetermined points in the tank main body.

### TECHNICAL FIELD

The present invention relates to a cutting fluid tank used for a machine tool such as a machining center and a lathe.

### BACKGROUND ART

In a machine tool such as a machining center and a lathe, for example, which performs cutting operations, a cutting fluid (coolant) is generally used for lubricating and cooling tools and discharging sludge.

A cutting fluid that has been ejected into a machining chamber (processing region) in which a cutting operation on a workpiece is performed is discharged from the processing region, together with sludge such as chips that are scraped off the workpiece. Of the sludge mixed in the cutting fluid thus discharged, relatively large lumps of the sludge are separated and removed from the cutting fluid by means of a chip conveyor and a filter. Thereafter, the cutting fluid flows into a tank main body of the cutting fluid tank and is temporarily stored therein. Then, the cutting fluid is supplied again from the tank main body to the processing region by a coolant pump.

Here, relatively small lumps of sludge that have not been separated and removed by means of the chip conveyor and the filter flow into the tank main body, together with the cutting fluid. Supplying the cutting fluid with such sludge being mixed therein into the processing region by the coolant pump may result in poor machinability, in some cases. In addition, when the sludge mixed in the cutting fluid accumulates on the bottom of the tank main body, the cutting fluid corrodes, which may impair the working environment, in some cases.

To deal with such situations, a means to separate and remove sludge from the cutting fluid stored in the tank main body in the cutting fluid tank is known. For example, Patent Literature 1 discloses configurations: in which a cutting fluid that is pumped up from inside a tank main body using a pump is sprayed from a nozzle, such that the cutting fluid is delivered along a wall surface of the tank main body to form a vortex flow of the cutting fluid in the tank main body, whereby chips are prevented from accumulating on a bottom of the tank main body; and in which the chips gathered at a central portion of the tank main body by the vortex flow are, together with the cutting fluid, pumped up using another pump, are caused to pass through a filter, and are returned to the tank main body again.

### CITATION LIST

### Patent Literature

Patent Literature 1: Japanese Utility Model Application Laid-Open Publication No. 7-7855

### SUMMARY OF INVENTION

### Technical Problem

However, in the case of the cutting fluid tank disclosed by Patent Literature 1 described above, if the chip conveyor or the like is disposed, for example, in the tank main body, the chip conveyor inhibits the flow of the cutting fluid, and the flow of the cutting becomes constant. Therefore, a location where sludge accumulates occurs and the sludge may not be sufficiently collected and removed, in some cases. In addition, in the above-described cutting fluid tank, when the operation is restarted after being suspended, a location where sludge remains accumulating on a bottom of the tank main body is likely to occur.

An object of the present invention is to provide a cutting fluid tank for a machine tool, which is capable of sufficiently collecting and removing sludge that is mixed in a cutting fluid even in a case where a chip conveyor or the like is disposed in a tank main body, and with which a location where sludge remains accumulating on a bottom of the tank main body is less likely to occur even when an operation is restarted after being suspended.

### Solution to Problem

The present invention includes the following aspects in order to achieve the above-described object.
1) A cutting fluid tank for a machine tool, including: a tank main body in which a sludge-containing cutting fluid that is discharged from a processing region of the machine tool flows in through a predetermined inflow point and is stored;

a first circulation pump disposed at a location in the tank main body, where a flow rate of the sludge-containing cutting fluid is relatively high, and having a suction opening that is open upward;

a sludge transfer nozzle configured to eject the sludge-containing cutting fluid that is pumped out from the tank main body by the first circulation pump, toward a sludge collection point in the tank main body;

a second circulation pump disposed at a location in the tank main body, where a flow rate of the sludge-containing cutting fluid is relatively low, and having a suction opening that is facing a bottom of the tank main body; and

first agitation nozzles configured to eject the sludge-containing cutting fluid that is pumped out from the tank main body by the second circulation pump, toward predetermined points in the tank main body.
2) The cutting fluid tank for a machine tool according to the aspect 1), further including: a second agitation nozzle configured to eject a part of the sludge-containing cutting fluid pumped out from the tank main body by the first circulation pump, toward a vicinity of the second circulation pump.
3) The cutting fluid tank for a machine tool according to the aspect 1) or the aspect 2), wherein the first agitation nozzles include a nozzle configured to eject the sludge-containing cutting fluid so as to form a flow of the sludge-containing cutting fluid from the inflow point, through the first circulation pump, to the second circulation pump.
4) The cutting fluid tank for a machine tool according to any one of the aspect 1) to the aspect 3), wherein the first agitation nozzles include a nozzle configured to eject the sludge-containing cutting fluid so as to form a flow of the sludge-containing cutting fluid from the inflow point to the sludge collection point.

### Advantageous Effects of Invention

With the cutting fluid tank for a machine tool in accordance with the aspect 1), through the suction opening of the first circulation pump, the cutting fluid containing a relatively large amount of sludge is sucked to be pumped out from the tank main body, and the sludge-containing cutting fluid is ejected from the sludge transfer nozzle toward the sludge collection point, whereby sludge is gathered at the sludge collection point efficiently. In addition, through the suction opening of the second circulation pump, the cutting fluid is sucked, together with the sludge accumulating on the bottom of the tank main body, to be pumped out from the tank main body, and the sludge-containing cutting fluid is ejected from the first agitation nozzles toward the predetermined points within the tank main body, whereby the sludge-containing cutting fluid in the tank main body is agitated, which reduces the locations where sludge accumulates on the bottom of the tank main body.

Thus, with the cutting fluid tank in accordance with the aspect 1), even in the case where the chip conveyor or the like is disposed in the tank main body, sludge that is mixed in a cutting fluid is sufficiently collected and removed, and even when an operation is restarted after being suspended, a location where sludge remains accumulating on the bottom of the tank main body is less likely to occur.

With the cutting fluid tank for a machine tool in accordance with the aspect 2), a part of the sludge-containing cutting fluid pumped out from the tank main body by the first circulation pump is ejected from the second agitation nozzle toward the vicinity of the second circulation pump, whereby sludge accumulating in the vicinity of the second circulation pump at the bottom of the tank main body is caused to swirl up, which facilitates suction of sludge through the suction opening of the second circulation pump, resulting in effective collection and removal of sludge.

With the cutting fluid tank for a machine tool in accordance with the aspect 3), the sludge-containing cutting fluid ejected from the first agitation nozzle forms a flow of the sludge-containing cutting fluid from the inflow point, through the first circulation pump, to the second circulation pump, whereby the above-described collection and removal of sludge is more efficiently performed.

With the cutting fluid tank for a machine tool in accordance with the aspect 4), the sludge-containing cutting fluid ejected from the first agitation nozzle forms a flow of the sludge-containing cutting fluid from the inflow point to the sludge collection point, whereby sludge is collected and removed effectively from the sludge-containing cutting fluid that does not flow through the first circulation pump and the second circulation pump.

### BRIEF DESCRIPTION OF DRAWINGS

FIG. 1 is a horizontal cross-sectional view, schematically illustrating a cutting fluid tank in accordance with an embodiment of the present invention.

FIG. 2 is a vertical cross-sectional view, schematically illustrating a left area of the cutting fluid tank.

FIG. 3 is a vertical cross-sectional view, schematically illustrating a right area of the cutting fluid tank.

### DESCRIPTION OF EMBODIMENTS

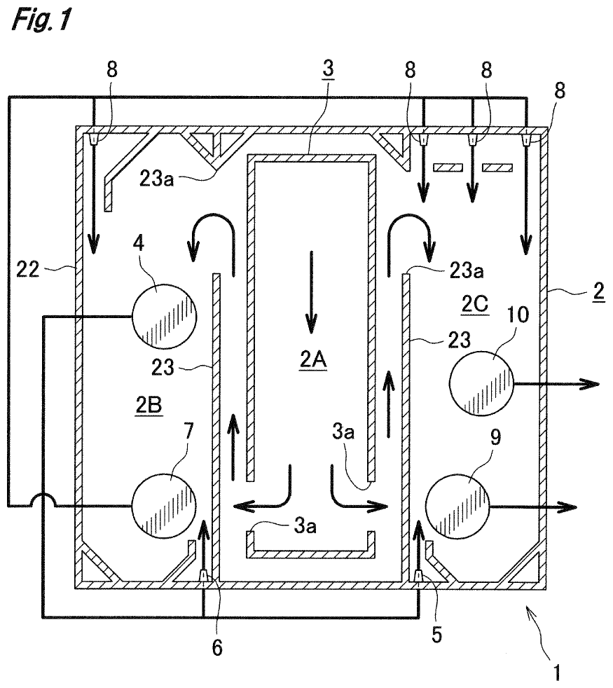

The embodiments of the present invention will be described below with reference to FIG. 1 to FIG. 3.

In the following description, the lower side and the upper side of FIG. 1 are referred to as front and rear, respectively. Likewise, the left and right sides of FIG. 1 are referred to as left and right, respectively.

A cutting fluid tank 1 of a machine tool, in accordance with the present embodiment includes a tank main body 2 in which a sludge-containing cutting fluid that is discharged from a processing region (not shown) of the machine tool flows in through inflow points 3a and is stored.

The tank main body 2 has a bottom wall 21 that is substantially rectangular in plan view, and a peripheral wall 22 that is vertically extending upward from a peripheral edge of the bottom wall 21. The tank main body 2 is provided at a middle portion in a left-right width direction thereof with a chip conveyor 3 that is elongated in the front-rear direction. The chip conveyor 3 is provided at front end portions of left and right side surfaces thereof with discharge openings 3a for the sludge-containing cutting fluid, which constitute the inflow points 3a. In addition, the tank main body 2 is provided with two (left and right) partition walls 23 such that an inside portion of the tank main body 2 is partitioned into a central area 2A where the chip conveyor 3 is disposed, a left area 2B, and a right area 2C, and communication openings 23a are formed at rear portions of the partition walls 23.

The left area 2B of the tank main body 2 is provided with: a first circulation pump 4, which is located at a longitudinally intermediate portion of the left area 2B and is located at a position immediately frontward of the communication opening 23a of the partition wall 23 with respect to the longitudinal direction; and a second circulation pump 7, which is located at a front end portion of the left area 2B. The first circulation pump 4 and the second circulation pump 7 are attached to a lid 24, which closes an upward opening of the left area 2B of the tank main body 2.

The right area 2C of the tank main body 2 is provided with: a sludge collection pump 9, which is located at a front end portion of the right area 2C; and a coolant pump 10 at a longitudinally central portion of the right area 2C. The sludge collection pump 9 and the coolant pump 10 are attached to the lid 24, which closes an upward opening of the right area 2C of the tank main body 2.

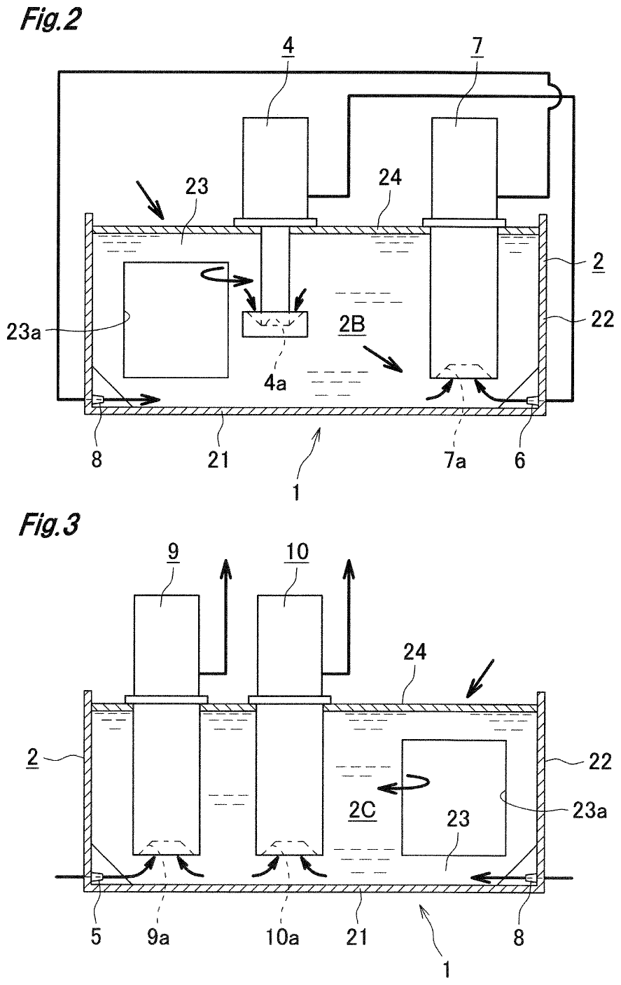

The first circulation pump 4 is provided at a lower end portion thereof with a suction opening 4a that is open upward. The placement of the suction opening 4a is not specifically limited as long as the suction opening 4a is placed below a fluid level of the sludge-containing cutting fluid stored in the tank main body 2. For example, as shown in FIG. 2, the suction opening 4a may be placed at approximately the same level as the middle in the height direction of the peripheral wall 22 of the tank main body 2, and, more preferably, is placed above the above-described middle level.

The sludge-containing cutting fluid that has been pumped out by the first circulation pump 4 flows through a circulation pipeline, and is ejected from a sludge transfer nozzle 5 disposed at a right side portion of a front wall portion of the peripheral wall 22, toward a vicinity of a suction opening 9a of the sludge collection pump 9, which is a sludge collection point.

In addition, a part of the sludge-containing cutting fluid that has been pumped out by the first circulation pump 4 branches off the above-described circulation pipeline, and is ejected from a second agitation nozzle 6 that is disposed at a left side portion of the front wall portion of the peripheral wall 22, toward a vicinity of a suction opening 7a of the second circulation pump 7.

The second circulation pump 7 is provided at a lower end portion thereof with the suction opening 7a that is open downward. The suction opening 7a is placed close to an upper surface of the bottom wall 21 of the tank main body 2 so as to face the upper surface.

The sludge-containing cutting fluid that has been pumped out by the second circulation pump 7 flows through a circulation pipeline, and is ejected from first agitation nozzles 8 disposed at both of left and right side portions of a rear wall portion of the peripheral wall 22, frontward within the tank main body 2. At least one of the first agitation nozzles 8 is disposed at each of the left and right side portions (in FIG. 1, one at the left side portion and three at the right side portion).

The sludge collection pump 9 is provided at a lower end portion thereof with a suction opening 9a that is open downward. The suction opening 9a is placed close to the upper surface of the bottom wall 21 of the tank main body 2 so as to face the upper surface.

The sludge-containing cutting fluid that has been pumped out by the sludge collection pump 9, for example, flows through a circulation pipeline, and is sent to a sludge separation device (for example, a filter) disposed outside the tank main body 2. A cutting fluid that is obtained through the separation and removal of sludge by the sludge separation device flows through a circulation pipeline, and is returned back to the tank main body 2 again.

The coolant pump 10 is configured to supply a cutting fluid in the tank main body 2 to the processing region of the machine tool.

The coolant pump 10 shown in FIG. 3 is provided at a lower end portion thereof with a suction opening 10a that is open downward. The suction opening 10a is placed close to the upper surface of the bottom wall 21 of the tank main body 2 so as to face the upper surface. The orientation and placement of the suction opening 10a is not limited to those shown in FIG. 3, and may be modified as appropriate. Although not shown, on the suction opening 10a or in the vicinity thereof, a sludge separation device consisting, for example, of a filter, a centrifugal separator, a magnet separator, or the like may be disposed.

With the cutting fluid tank 1 described above, sludge contained in the cutting fluid stored in the tank main body 2 is collected and removed as follows.

Specifically stated, the sludge-containing cutting fluid that has flowed in through the left and right discharge openings 3a of the chip conveyor 3 to the central area 2A of the tank main body 2 flows rearward through passages formed between the chip conveyor 3 and the left and right partition walls 23, flows into the left area 2B and the right area 2C through the respective communication openings 23a, and flows forward within these areas 2B and 2C.

In the left area 2B, the flow rate of the sludge-containing cutting fluid is relatively high in the vicinity of the first circulation pump 4. Therefore, almost no sludge accumulates on the upper surface of the bottom wall 21 of the tank main body 2, and most of the sludge is in a state of being mixed in the flow of the cutting fluid. The cutting fluid thus containing a large amount of sludge is pumped through the suction opening 4a that is open upward, by the first circulation pump 4, then flows through a circulation pipeline, and is ejected from the sludge transfer nozzle 5 toward the vicinity of the suction opening 9a of the sludge collection pump 9 that is located at the front end portion of the right area 2C. This allows most of the sludge included in the cutting fluid that has flowed into the left area 2B to be transferred to the vicinity of the suction opening 9a of the sludge collection pump 9, which is a sludge collection point, and is collected at the suction opening 9a.

The sludge-containing cutting fluid that has flowed forward in the left area 2B to reach the vicinity of the second circulation pump 7 has a flow rate that is relatively low as compared to that in the vicinity of the first circulation pump 4. Therefore, sludge is likely to accumulate on the upper surface of the bottom wall 21 of the tank main body 2. The accumulated sludge is pumped through the suction opening 7a, which is open downward, by the second circulation pump 7, together with the cutting fluid, flows through a circulation pipeline, and is ejected from the plurality of first agitation nozzles 8 located at the rear end portions of the left area 2B and the right area 2C, forward in the left area 2B and the right area 2C. This allows the flow of the sludge-containing cutting fluid, which is directed from the back side to the front side, to be formed more reliably, in both of the left and right side areas 2B, 2C.

In addition, a part of the sludge-containing cutting fluid that has been pumped out by the first circulation pump 4 branches off the circulation pipeline, and is ejected from the second agitation nozzle 6 toward the vicinity of the suction opening 7a of the second circulation pump 7 that is located at the front end portion of the left area 2B. This causes the sludge accumulating on the upper surface of the bottom wall 21 of the tank main body 2 to swirl up in the vicinity of the second circulation pump 7, whereby sludge becomes easily pumped through the suction opening 7a of the second circulation pump 7. Thus, sludge is further more efficiently collected and removed.

By contrast, in the right area 2C, the sludge-containing cutting fluid that has flowed forward in the right area 2C to reach the vicinity of the sludge collection pump 9 has a flow rate that is relatively low as compared to that in the vicinity of the communication opening 23a, and therefore, the sludge easily accumulates on the upper surface of the bottom wall 21 of the tank main body 2. A cutting fluid containing the accumulated sludge is pumped through the suction opening 9a, which is open downward, by the sludge collection pump 9, then flows through a circulation pipeline, and is sent to the sludge separation device outside the tank main body 2. At this time, the sludge-containing cutting fluid is ejected from the sludge transfer nozzle 5 toward the vicinity of the suction opening 9a of the sludge collection pump 9. This causes the sludge accumulating on the upper surface of the bottom wall 21 in the vicinity of the suction opening 9a to swirl up, which facilitates suction of the sludge through the suction opening 9a, whereby collection and removal of sludge is efficiently performed.

Thus, with the cutting fluid tank 1 described above, almost no locations where sludge remains accumulating exist, and therefore sludge is collected and removed from the cutting fluid efficiently. In addition, with the cutting fluid tank described above, the location where sludge remains accumulating on the bottom of the tank main body 2 does not occur even when the operation is restarted after being suspended.

### REFERENCE SIGNS LIST

1: cutting fluid tank
2: tank main body
21: bottom wall (bottom) of tank main body
3: chip conveyor
3a: discharge opening (inflow point)
4: first circulation pump
4a: suction opening of first circulation pump
5: sludge transfer nozzle
6: second agitation nozzle
7: second circulation pump
7a: suction opening of second circulation pump
8: first agitation nozzle
9: sludge collection pump (sludge collection point)
10: coolant pump

1. A cutting fluid tank for a machine tool, comprising:
a tank main body in which a sludge-containing cutting fluid that is discharged from a processing region of the machine tool flows in through a predetermined inflow point and is stored;
a first circulation pump disposed at a location in the tank main body, where a flow rate of the sludge-containing cutting fluid is relatively high, and having a suction opening that is open upward;
a sludge transfer nozzle configured to eject the sludge-containing cutting fluid that is pumped out from the tank main body by the first circulation pump, toward a sludge collection point in the tank main body;
a second circulation pump disposed at a location in the tank main body, where a flow rate of the sludge-containing cutting fluid is relatively low, and having a suction opening that is facing a bottom of the tank main body; and
first agitation nozzles configured to eject the sludge-containing cutting fluid that is pumped out from the tank main body by the second circulation pump, toward predetermined points in the tank main body.

2. The cutting fluid tank for a machine tool according to claim 1, further comprising:
a second agitation nozzle configured to eject a part of the sludge-containing cutting fluid pumped out from the tank main body by the first circulation pump, toward a vicinity of the second circulation pump.

3. The cutting fluid tank for a machine tool according to claim 1, wherein the first agitation nozzles include a nozzle configured to eject the sludge-containing cutting fluid so as to form a flow of the sludge-containing cutting fluid from the inflow point, through the first circulation pump, to the second circulation pump.

4. The cutting fluid tank for a machine tool according to claim 1, wherein the first agitation nozzles include a nozzle configured to eject the sludge-containing cutting fluid so as to form a flow of the sludge-containing cutting fluid from the inflow point to the sludge collection point.
